(19) United States
(12) Patent Application Publication
(10) Pub. No.: US 2023/0277005 A1
(43) Pub. Date: Sep. 7, 2023

(54) Handheld milk frother

(71) Applicants: Yan Lam Napolia LEE, Kwun Tong (HK); Wing Yin CHUNG, Lam Tin (HK)

(72) Inventors: Yan Lam Napolia LEE, Kwun Tong (HK); Wing Yin CHUNG, Lam Tin (HK)

(21) Appl. No.: 17/684,427

(22) Filed: Mar. 2, 2022

(51) Int. Cl. A47J 43/10

(52) U.S. Cl. CPC A47J 43/1093

(57) ABSTRACT

A handheld electric milk frother including a handle and an immersing portion coupled with the handle. The immersing portion includes a cap and a rotatable frothing means coupled with the cap. The frothing means includes a substantially closed ring member formed by a first half ring member and a second half ring member joining with each other, with the first half ring member oriented horizontally and the second half ring member oriented obliquely relative to the first half ring member and extending downwardly from the first half ring member, so that an obtuse angle is formed between the first and second half ring members; and a plurality of coils wound on the substantially closed ring member. The cap has an upper part and the upper part has the largest cross section thereof larger than and sufficient to cover the largest cross section of the substantially closed ring member.

### BACKGROUND OF THE INVENTION

The present invention relates to a milk frothing apparatus and more particularly pertains to a handheld electric milk frother.

Mircofoam milk is essential for creating latte art. However, microfoam milk is not easy to prepare, especially with handheld electric milk frothers. A conventional handheld electric milk frother has a wand with a whisk at the end. Typically, the whisk quickly spins the milk to create a big vortex in the center and injects a large volume of air into the milk, resulting in froth with bubbles that are too large in size to be mixed well with the espresso drink and permit the desirable latte art. To create the desirable microfoam milk for latte art, special technique is required for frothing the milk. For example, the pitcher has to be tilted to a certain degree, the whisk has to be positioned at a particular place before frothing, and the whisk has to be moved up and down during the frothing process, so that the right amount of air is injected into the milk and the air is sufficiently mixed with the milk to create microfoam milk with the right texture and consistency.

### BRIEF SUMMARY OF THE INVENTION

In view of the aforesaid disadvantages now present in the prior art, the object of the present invention is to provide a handheld electric milk frother which is capable of creating microfoam milk with the right texture and consistency for latte art.

To attain this, the present invention provides a handheld electric milk frother comprising a handle and an immersing portion coupled with the handle and configured to be immersed in a container receiving a liquid to be frothed, wherein the immersing portion comprises a cap and a rotatable frothing means coupled with the cap. The frothing means comprises a substantially closed ring member formed by a first half ring member and a second half ring member joining with each other, with the first half ring member oriented horizontally and the second half ring member oriented obliquely relative to the first half ring member and extending downwardly from the first half ring member, so that an obtuse angle is formed between the first half ring member and the second half ring member; and a plurality of coils wound on the substantially closed ring member. The cap has an upper part and the upper part has the largest cross section thereof larger than and sufficient to cover the largest cross section of the substantially closed ring member.

The cap has a lower part underneath the upper part, and the lower part is in shape of an inverted frustum.

The obtuse angle between the first half ring member and the second half ring member is within 134° to 154°.

The first half ring member and the second half ring member are substantially the same in terms of horizontal length.

The handle has a lower end which is threadedly connected to the cap; a sealing ring is disposed between the handle and the cap.

A driving means is connected to the frothing means for driving rotation of the frothing means.

The driving means comprises a motor disposed in the handle, and a rotating shaft with a first end thereof coupled with the motor and a second end thereof coupled with the frothing means.

The second end of the rotating shaft is in form of an L-shaped section with an outer end of a horizontal section of the L-shaped section connecting with the first half ring member.

A mode switching means functioning to switch between a plurality of operation modes is connected with the driving means to adjust rotational speed of the driving means according to the operation mode selected.

### BRIEF DESCRIPTION OF THE DRAWINGS

FIG. 1 is a front view of an embodiment of the present invention.

FIG. 2 is a sectional view of the embodiment as shown in FIG. 1.

FIG. 3 is another sectional view of the embodiment as shown in FIG. 1.

FIG. 4 is a perspective view of the immersing portion of the embodiment as shown in FIG. 1.

FIG. 5 is a perspective view of the driving means and the frothing means of the embodiment as shown in FIG. 1.

### DETAILED DESCRIPTION OF THE INVENTION

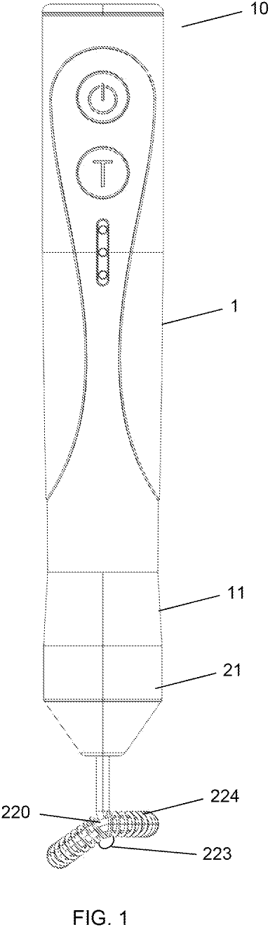

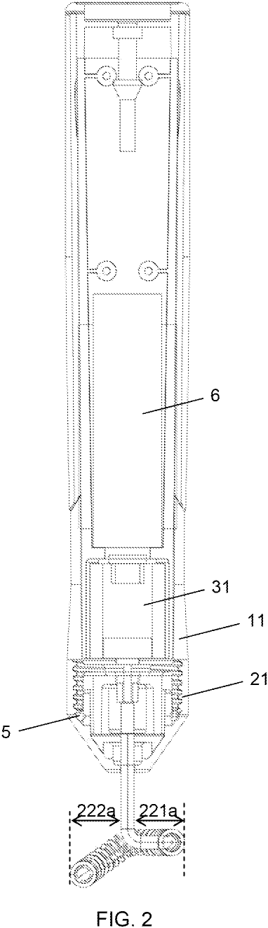

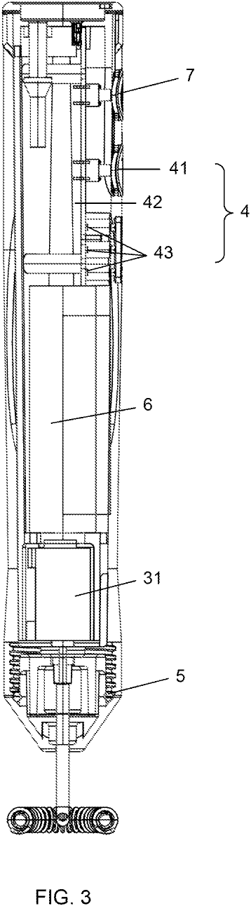

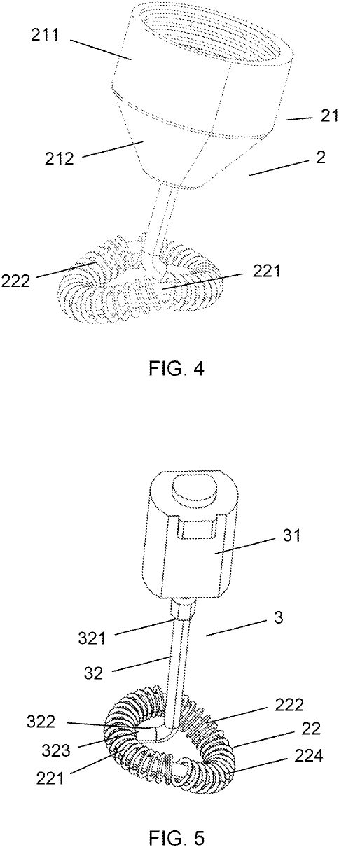

As illustrated in FIGS. 1 to 5, the present embodiment provides a handheld electric milk frother 10 comprising a handle 1 and an immersing portion 2. The immersing portion 2 is coupled with the handle 1 and configured to be immersed in a container receiving a liquid, such as milk, to be frothed. The immersing portion 2 comprises a cap 21 and a rotatable frothing means 22 coupled with the cap 21.

The frothing means 22 comprises a substantially closed ring member 220 formed by a first half ring member 221 and a second half ring member 222 joining with each other, with the first half ring member 221 oriented horizontally and the second half ring member 222 oriented obliquely relative to the first half ring member 221 and extending downwardly from the first half ring member 221, so that an obtuse angle 223 is formed between the first half ring member 221 and the second half ring member 222. The first half ring member 221 and the second half ring member 222 are substantially the same in terms of horizontal length (221a, 222a), with the horizontal length of the second half ring member 222 having a tolerance of +/- 15% in relation to the horizontal length of the first half ring member 221. A plurality of coils 224 are wound on the substantially closed ring member 220. The obtuse angle 223 between the first half ring member 221 and the second half ring member 221 is 144° in the present embodiment, but in other embodiments the obtuse angle 223 may be between 134° and 154°.

The cap 21 has an upper part 211 and the upper part 211 has the largest cross section thereof larger than and sufficient to cover the largest cross section of the substantially closed ring member 220, and a lower part 212 underneath the upper part 211 which is in shape of an inverted frustum.

A driving means 3 is connected to the frothing means 22 for driving rotation of the frothing means 22. The driving means 3 comprises a motor 31 disposed in the handle 1, and a rotating shaft 32 with a first end 321 thereof coupled with the motor 31 and a second end 322 thereof coupled with the frothing means 22. In this embodiment, the second end 322 of the rotating shaft 32 is in form of an L-shaped section with an outer end 323 of a horizontal section of the L-shaped section connecting with the first half ring member 221.

In this embodiment, a mode switching means 4 functioning to switch between a plurality of operation modes is connected with the driving means 3 to adjust rotational speed of the driving means 3 according to the operation mode selected. The mode switching means 4 comprises a switch button 41, a printed circuit board 42 electrically connected with the switch button 41 and the motor 31 of the driving means 3. LEDs 43 are electrically connected to the printed circuit board 42 for indicating the mode selected. The structures and operation of the mode switching means 4 are widely available in the prior art and are therefore not detailed herein.

The handle 1 has a lower end 11 which is threadedly connected to the cap 21. A sealing ring 5 is disposed between the handle 1 and the cap 21 to prevent the liquid from leaking into the handle 1 and damaging the driving means 3 and the mode switching means 4.

In this embodiment, the handheld electric milk frother 10 is powered by a battery 6 disposed in the handle 1. The battery 6 is electrically connected to the driving means 3 and the mode switching means 4 to provide power supply thereto. An on/off switch 7 is also provided for switching on or off the handheld electric milk frother 10.

The present embodiment operates as follows:

To froth a liquid (e.g. milk) in a container, first immerse the entire immersing portion 2 into the liquid. At this time, the immersing portion 2 should be suspended in the middle of the container so that it is not in contact with the inner wall of the container. As an example, the container in this embodiment is a typical container used for frothing milk, which is about 8 cm in diameter and 12 cm in height; the container is filled with about 200 ml-250 ml of milk, which should fill about half of the container. The first half ring member 221 and the second half ring member 222 are each about 27 mm in horizontal length.

Then, the user switches on the handheld electric milk frother 10 by pressing the on/off switch 7, and selects the desired operation mode by pressing the switch button 41. In the present embodiment, three operation modes are provided, namely “strong”, “medium” and “weak”, with the “strong” operation mode associated with the fastest rotational speed of the driving means 3, and the “weak” operation mode associated with the slowest rotational speed of the driving means 4. In this embodiment, the rotational speed of the driving means 3 is 6000 rpm in the “strong” operation mode, 4800 rpm in the “medium” operation mode and 3600 rpm in the “weak” operation mode. The “strong” operation mode is used for creating microfoam milk more suitable for cappuccino; the “medium” operation mode is used for creating microfoam milk more suitable for latte; the “weak” operation mode is used for creating microfoam milk more suitable for flat white.

The motor 31 of the driving means 3 then drives the frothing means 22 to rotate at the selected rotational speed. The frothing means 22 is specially shaped to increase the contact surface area between the frothing means 22 and the liquid, thus creating a vortex in shape of a lemniscate, or figure-eight, or infinity symbol and resulting in microfoam with higher consistency. Besides, as the entire immersing portion 2 is immersed in the liquid in the container, the immersing portion 2 prevents excessive air from being drawn into the liquid as the liquid is agitated by the frothing means 22, resulting in microfoam that make a light texture foam around the circumference of the cap 21.

During the entire frothing process, there is no need to move the handheld electric milk frother 10 up and down or to move or tilt the container. When the liquid is frothed to the desired texture and consistency, the user then presses the on/off switch 7 to stop rotation of the frothing means 22 and thereafter removes the handheld electric milk frother 10 from the liquid.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A handheld electric milk frother comprising:
a handle;
an immersing portion coupled with the handle and configured to be immersed in a container receiving a liquid to be frothed;
wherein the immersing portion comprises a cap and a rotatable frothing means coupled with the cap;
the frothing means comprises
a substantially closed ring member formed by a first half ring member and a second half ring member joining with each other, with the first half ring member oriented horizontally and the second half ring member oriented obliquely relative to the first half ring member and extending downwardly from the first half ring member, so that an obtuse angle is formed between the first half ring member and the second half ring member; and
a plurality of coils wound on the substantially closed ring member;
the cap has an upper part and the upper part has the largest cross section thereof larger than and sufficient to cover the largest cross section of the substantially closed ring member.

2. The handheld electric milk frother as in claim 1, wherein the cap has a lower part underneath the upper part, and the lower part is in shape of an inverted frustum.

3. The handheld electric milk frother as in claim 1, wherein the obtuse angle between the first half ring member and the second half ring member is within 134° to 154°.

4. The handheld electric milk frother as in claim 1, wherein the first half ring member and the second half ring member are substantially the same in terms of horizontal length.

5. The handheld electric milk frother as in claim 1, wherein the handle has a lower end which is threadedly connected to the cap; a sealing ring is disposed between the handle and the cap.

6. The handheld electric milk frother as in claim 1, wherein a driving means is connected to the frothing means for driving rotation of the frothing means.

7. The handheld electric milk frother as in claim 6, wherein the driving means comprises a motor disposed in the handle, and a rotating shaft with a first end thereof coupled with the motor and a second end thereof coupled with the frothing means.

8. The handheld electric milk frother as in claim 7, wherein the second end of the rotating shaft is in form of an L-shaped section with an outer end of a horizontal section of the L-shaped section connecting with the first half ring member.

9. The handheld electric milk frother as in claim 1, wherein a mode switching means functioning to switch between a plurality of operation modes is connected with the driving means to adjust rotational speed of the driving means according to the operation mode selected.
